(19) United States
(12) Patent Application Publication
(10) Pub. No.: US 2021/0385558 A1
(43) Pub. Date: Dec. 9, 2021

(54) VIDEO PROCESSING SYSTEM AND RELATED METHODS

(71) Applicants: Jess D. Walker, Georgetown, TX (US); David E. Johnson, Cedar Park, TX (US); Chris Rebstock, Round Rock, TX (US)

(72) Inventors: Jess D. Walker, Georgetown, TX (US); David E. Johnson, Cedar Park, TX (US); Chris Rebstock, Round Rock, TX (US)

(21) Appl. No.: 17/341,904

(22) Filed: Jun. 8, 2021

Related U.S. Application Data
(60) Provisional application No. 63/036,674, filed on Jun. 9, 2020.

(51) Int. Cl. H04N 21/8549; G06F 16/783; G06F 16/78; G06F 16/787; H04N 21/2187

(52) U.S. Cl. CPC H04N 21/8549; G06F 16/783; H04N 21/2187; G06F 16/787; G06F 16/7867

(57) ABSTRACT

A video processing system may include a user device that includes a video camera, an input device, and a controller coupled to the video camera and the input device. The controller may acquire a video clip via the video camera of a live performance, and permit input via the input device to mark a live performance highlight within the video clip of the live performance. The video processing system may also include a video processing server that includes processor and an associated memory. The processor may obtain the video clip of the live performance including the marked live performance highlight from the user device, and process the video clip of the live performance to generate a video highlight clip based upon the marked live performance highlight. The processor may also communicate the video highlight clip corresponding to the marked performance highlight to the user device for display thereon.

### RELATED APPLICATIONS

The present application claims the priority benefit of provisional application Ser. No. 63/036,674 filed on Jun. 9, 2020, the entire contents of which are herein incorporated by reference.

### TECHNICAL FIELD

The present invention relates to the field of electronics, and more particularly, to video processing and related methods.

### BACKGROUND

A video is a series of recorded still images that when played back define visual movement. A video, for example, may be recorded digitally to an electronic medium. A video may be edited, for example, to clip specific time periods from the video.

Several types of electronic devices are capable of recording a video. For example, a camcorder may record a video either to a digital storage medium or a magnetic storage medium. Another type of electronic device capable of recording a video is a mobile wireless communications, such as, for example, a mobile or smart phone. A mobile phone may also have video playback capabilities on its display.

U.S. Patent Application Publication No. 2009/0132924 to Vasa et al. is directed to a system for creating highlight portions of media content. More particularly, an electronic device is for creating highlights of a media file. The electronic device includes a media player for playing media files, wherein each media file has associated metadata and an input device. A controller is configured to receive at least one input from the input device corresponding to a mark for a highlight portion of a media file, wherein the controller incorporates the mark for the highlight portion into the metadata associated with the media file to segment the highlight portion within the media file; and wherein the controller is further configured to extract the highlight mark from the metadata to cause the media player to play only the highlight portion of the media file. Video files also may be streamed to the device, either from a recorded source or from a live broadcast or feed.

U.S. Pat. No. 10,572,735 to Han et al. is directed to detecting sports video highlights. More particularly, Han et al. discloses detecting in real time video highlights in a sports video at a mobile computing device. A highlight detection module of the mobile computing device extracts visual features from each video frame of the sports video using a trained feature model and detects a highlight in the video frame based on the extracted visual features of the video frame using a trained detection model. The feature model and detection model are trained with a convolutional neural network on a large corpus of videos to generate category level and pair-wise frame feature vectors. Based on the detection, the highlight detection module generates a highlight score for each video frame of the sports video and presents the highlight scores to users of the computing device. The feature model and detection model are dynamically updated based on the real time highlight detection data collected by the mobile computing device.

U.S. Pat. No. 9,619,891 to Bose et al. is directed to an event analysis and tagging system. More particularly, Bose et al. discloses a system that analyzes data from sensors and video cameras to generated synchronized event videos and to automatically select or generate tags for an event. Enables creating, transferring, obtaining, and storing concise event videos generally without non-event video. Events stored in the database identifies trends, correlations, models, and patterns in event data. Tags may represent for example activity types, players, performance levels, or scoring results. The system may analyze social media postings to confirm or augment event tags. Users may filter and analyze saved events based on the assigned tags. The system may create highlight and fail reels filtered by metrics and by tags.

### SUMMARY

A video processing system may include a user device that includes a video camera, an input device, and a controller coupled to the video camera and the input device. The controller may be configured to acquire a video clip via the video camera of a live performance, and permit input via the input device to mark a live performance highlight within the video clip of the live performance. The video processing system may also include a video processing server that includes a processor and an associated memory. The processor may be configured to obtain the video clip of the live performance including the marked live performance highlight from the user device, and process the video clip of the live performance to generate a video highlight clip based upon the marked live performance highlight. The processor may also be configured to communicate the video highlight clip corresponding to the marked performance highlight to the user device for display thereon.

The video processing server may be configured to process the video clip to generate the video highlight clip by moving backward a threshold time before the marked live performance highlight, for example. The video processing server may be configured to process the video clip to generate the video highlight clip by moving forward a threshold time after the marked live performance highlight, for example.

The user device may be configured to associate metadata with the video clip. The video processing server may be configured to process the video clip to generate the video highlight clip based upon the metadata, for example. The metadata may include at least one of username, geographic location, time, team name, and account information, for example.

The video processing system may include a further user device configured to acquire a further video clip of the live performance. The video processing server may be configured to aggregate the further video clip with the video clip of the live performance, for example.

The video processing system may include a further user device configured to permit input to mark a further live performance highlight. The user device may include wireless communications circuitry and a display coupled to the controller, for example.

The input device may include an accelerometer. The input to the input device may include movement of the user device while acquiring the video clip, for example.

Another device aspect is directed to a user device for a video processing system. The user device may include a video camera, an input device, and a controller coupled to the video camera and the input device. The controller may be configured to acquire a video clip via the video camera of a live performance, and permit input via the input device to mark a live performance highlight within the video clip of the live performance. The controller may also be configured to process the video clip of the live performance to generate a video highlight clip based upon the marked live performance highlight.

A method aspect is directed to a video processing method that may include operating a user device of a video processing system to acquire a video clip of a live performance via a video camera of the user device. The method may also include operating the user device to permit input via an input device of the user device to mark a live performance highlight within the video clip of the live performance, and process the video clip of the live performance to generate a video highlight clip based upon the marked live performance highlight.

Another method aspect is directed to a video processing method that may include operating a video processing server of a video processing system to obtain a video clip of a live performance from a video camera of a user device of the video processing system. The video clip of the live performance may include a marked live performance highlight marked via an input device from the user device. The method may further include operating the video processing server to process the video clip of the live performance to generate a video highlight clip based upon the marked live performance highlight, and communicate the video highlight clip corresponding to the marked performance highlight to the user device for display thereon.

### BRIEF DESCRIPTION OF THE DRAWINGS

FIG. 1 is a schematic diagram of a video processing system in accordance with an embodiment.

FIG. 2 is a schematic block diagram of the video processing system of FIG. 1.

FIG. 3 is an exemplary screen shot from a user device of the video processing system in accordance with an embodiment.

FIG. 4 is another exemplary screen shot from a user device of the video processing system in accordance with an embodiment.

FIG. 5 is another exemplary screen shot from a user device of the video processing system in accordance with an embodiment.

FIG. 6 is another exemplary screen shot from a user device of the video processing system in accordance with an embodiment.

FIG. 7 is another exemplary screen shot from a user device of the video processing system in accordance with an embodiment.

FIG. 8 is another exemplary screen shot from a user device of the video processing system in accordance with an embodiment.

FIG. 9 is another exemplary screen shot from a user device of the video processing system in accordance with an embodiment.

FIG. 10 is another exemplary screen shot from a user device of the video processing system in accordance with an embodiment.

FIG. 11 is another exemplary screen shot from a user device of the video processing system in accordance with an embodiment.

FIG. 12 is another exemplary screen shot from a user device of the video processing system in accordance with an embodiment.

FIG. 13 is another exemplary screen shot from a user device of the video processing system in accordance with an embodiment.

FIG. 14 is another exemplary screen shot from a user device of the video processing system in accordance with an embodiment.

FIG. 15 is another exemplary screen shot from a user device of the video processing system in accordance with an embodiment.

FIG. 16 is another exemplary screen shot from a user device of the video processing system in accordance with an embodiment.

FIG. 17 is another exemplary screen shot from a user device of the video processing system in accordance with an embodiment.

FIG. 18 is a schematic diagram of a user device for a video processing system in accordance with another embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

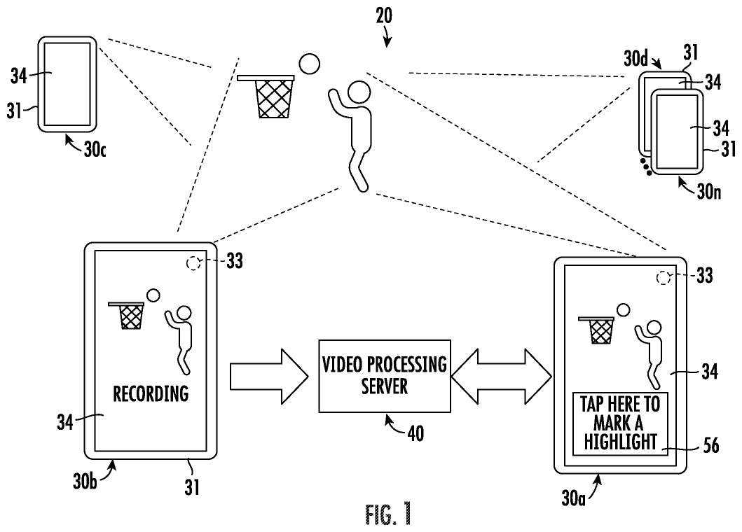

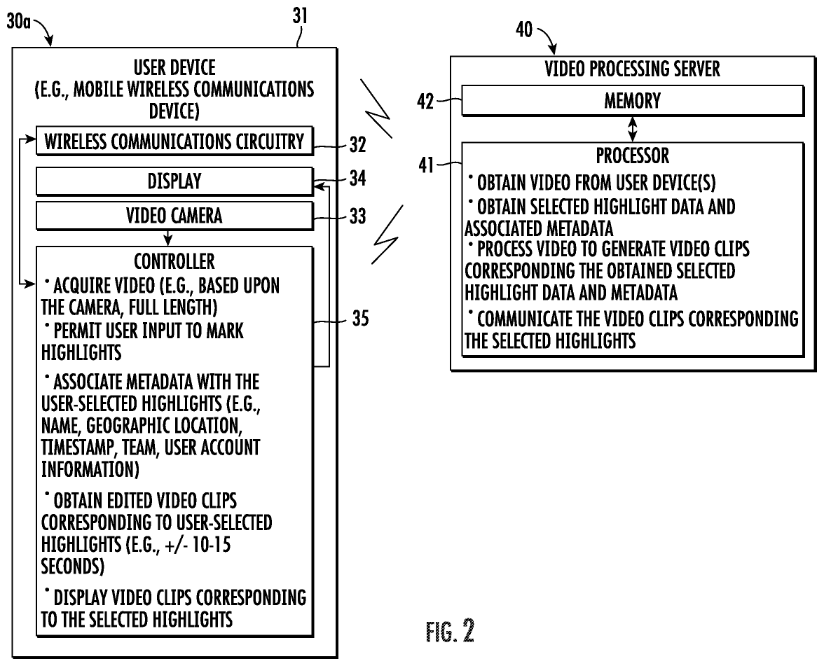

Referring initially to FIGS. 1-2, a video processing system 20 includes a user device 30a that is illustratively in the form of a mobile wireless communications device. The mobile wireless communications device 30a may be in the form of a smartphone or tablet computer, for example, and may include a housing 31, wireless communications circuitry 32 carried by the housing, a video camera 33 or other video input device for capturing video images and associated audio carried by the housing, and a display 34 also carried by the housing. An input device 36 may also be carried by the housing 31 for accepting input from a user. The input device 36 may be in the form of a touch portion of the display 34 or a pushbutton switch, for example. Additional input and/or output devices may be carried by the housing. A controller 35 is coupled to the video camera, display 34, input device 36, and wireless communications circuitry 32. The user device 30a may be in the form of another type of device.

The video processing system 20 also includes a video processing server 40. The video processing server 40 includes a processor 41 and an associated memory 42. The memory 42 may store an application that includes instructions for performing the operations described herein. While operations of the video processing server 40 are described herein, it will be appreciated that the operations are performed by way of cooperation between the processor 41 and the memory 42. The video processing server 40 wirelessly communicates with the mobile wireless communications device 30a via the wireless communications circuitry 32 using one or more wireless networks, such as, for example, the internet.

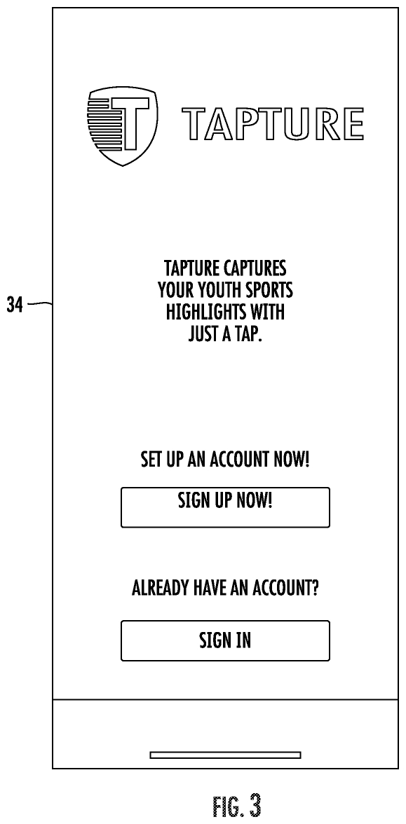

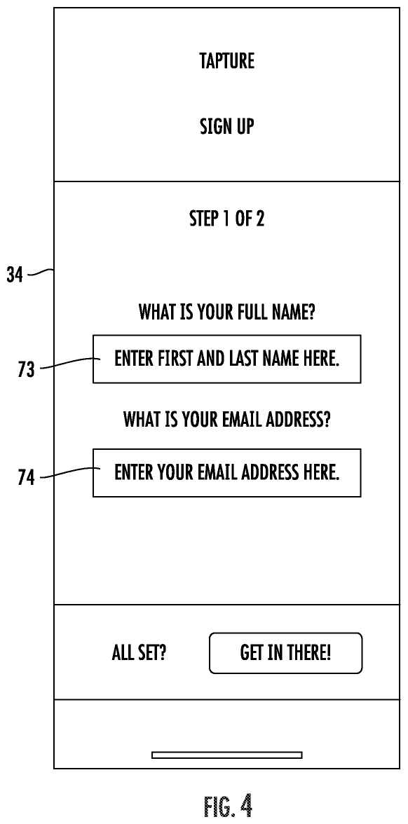

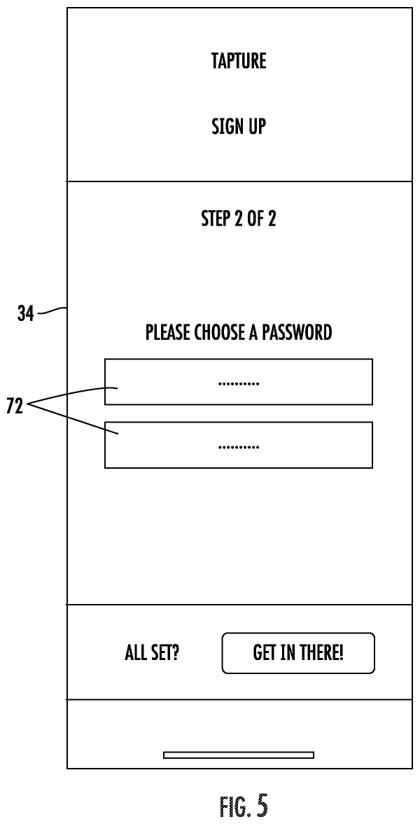

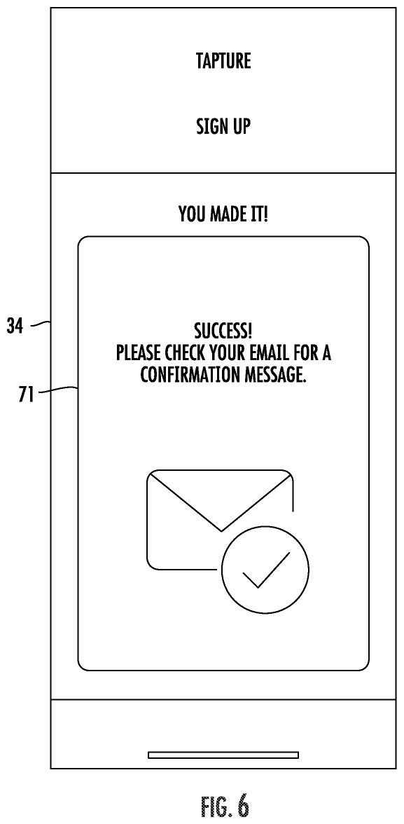

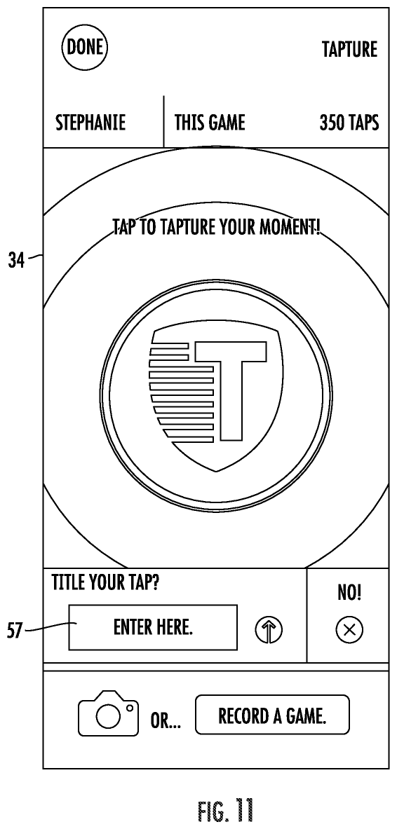

Referring additionally to FIGS. 3-17, operation of the video processing system 20 will be described with respect to exemplary screen-shots on the display 34 of the mobile wireless communications device 30a. As will be appreciated by those skilled in the art, certain operations may be performed by the mobile wireless communications device 30a by way of an application and independently from cooperation with the video processing server 40. For example, a given user may launch or open an application on the mobile wireless communications device 30a, which upon start up may prompt the given user via the display 34 to provide login credentials or sign up for an account (FIG. 3). The mobile wireless communications device 30a wirelessly communicates with the video processing server 40 to access the given user's account or to register the given user for an account. If the given user is a new user, the given user may be prompted for their full name 73 and email address 74 (FIG. 4), and may be prompted to select a password 72 (FIG. 5). In some embodiments, the given user's phone number may also be used. Upon successful account creation, a confirmation, for example, an email confirmation, may be communicated to the given user by the video processing server 40, and a corresponding notification 71 of the email confirmation may be displayed on the display 34 (FIG. 6). In some embodiments, creation and maintenance of the user accounts may be performed by a third-party service, which may cooperate with the video processing server 40. In some embodiments, the account creation and maintenance functions, even though performed by a third-party service, may be considered functions of the video processing server 40.

The given user's account may be associated with a given organization or group, for example, a sport, sport's team, or sport's league. The association may be based upon the given user's name, phone number, and/or email address, geographic location (e.g., at a special event, such as, for example, a tournament), or, in some embodiments, a referral code or source may be provided by the given user.

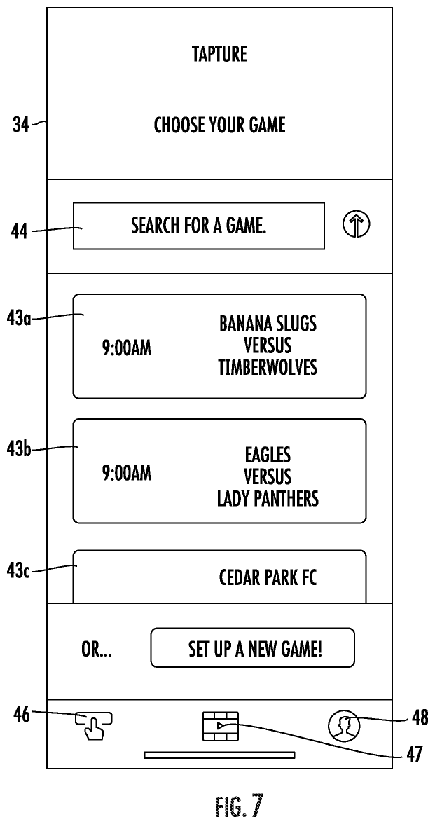

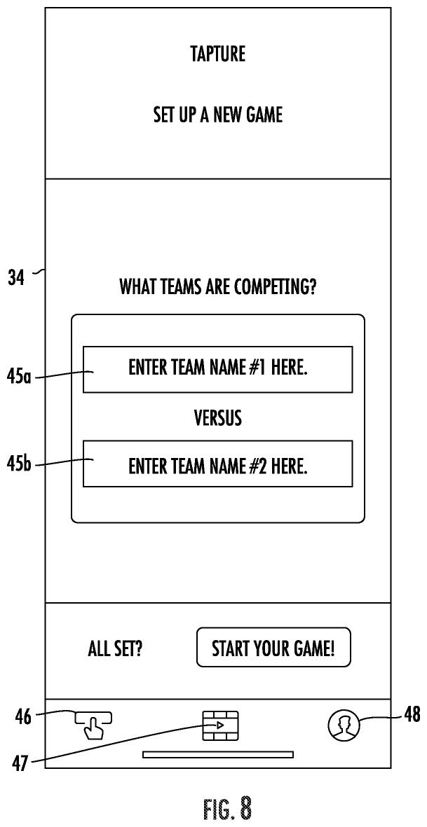

Upon a successful login via the application on the mobile wireless communications device 30a, the given user may be prompted to choose a sporting event 43a-43c, for example, to associate with a video capture or video clip (FIG. 7). Of course, while a sporting event 43a-43c is described, another type of event or live performance may be selected for video capturing or acquisition. A search box 44 may be provided to permit the given user to search for a game or sporting event that may not be listed. In some embodiments a user's account may be associated with a given team, opponent, or league, and based thereon, the given user may receive push notifications inviting the given user to join or select the sporting event or game. Icons 46, 47, 48 may be displayed on the display 34 and correspond to a menu function with the application, such as for example, setup, video functions, and user account settings, respectively (FIGS. 7 and 8).

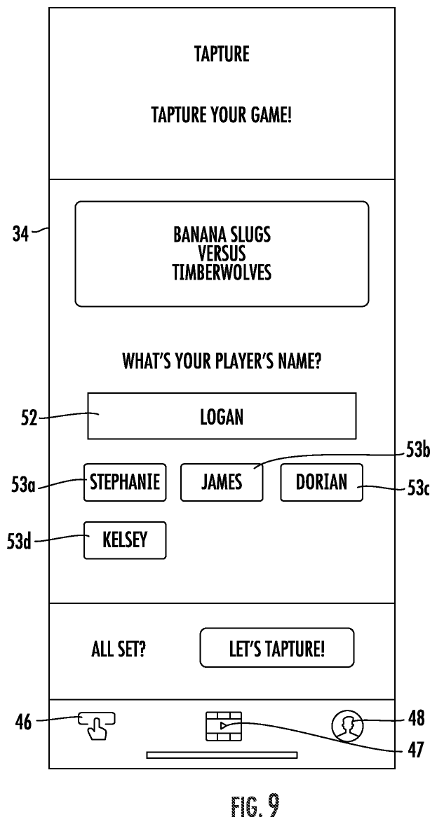

To setup a new game, for example, the given user is prompted to enter competing teams within corresponding text inputs 45a, 45b (FIG. 8). The given user is also prompted, upon entering the competing teams, the name of the player, via a text input 52, associated with the captured video by the given user. A listing of player names 53a-53d, for example, already associated with either or both of the competing teams, may be displayed on the display 34, for user selection (FIG. 9).

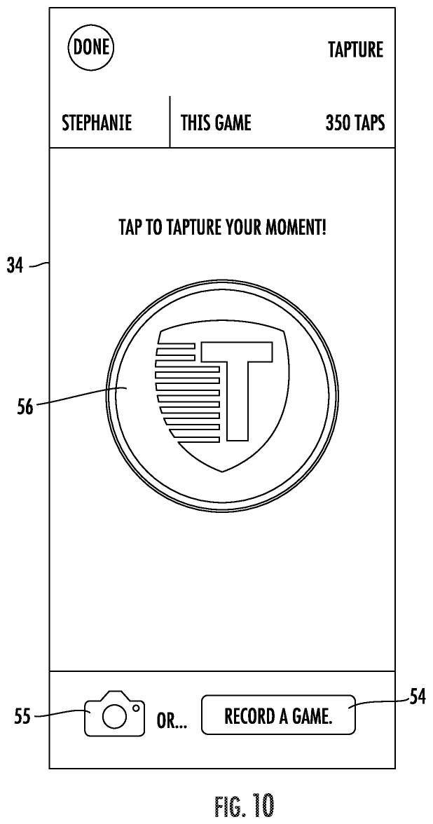

Upon completion of registration and selection of a player, the given user is prompted to capture or acquire video (i.e., record a game) 54 or a video clip, an image 55, or to provide input to note or mark a desired video capture moment 56 or highlight within the video clip (FIG. 10). If the given user provides input to capture or acquire a desired video clip, moment, or highlight, metadata is communicated from the mobile wireless communications device 30a to the video processing server 40. The metadata may include a timestamp (date, time), for example, based upon a mobile device or mobile carrier time settings associated with the user input. Input to capture a desired video clip, moment, or highlight may be provided manually, and/or based upon other functions. For example, the given user's mobile wireless communications device 30a may sense acceleration from an accelerometer 37 and cooperate with the controller 35 to determine a “twisting motion” and/or cooperate with the display 34 when in the form of touch screen to sense a “tap” sequence, for example, a double “tap.”

The metadata may also include information associated with the given user and the associated game, for example, team names, player name, username, email address, title or description of the highlight 57, weather, geographic location (e.g., based upon a global positioning system, user input, and/or wireless network), desired length of the highlight (e.g., configurable on a per-user account basis), etc. Metadata may also include the distance of the camera to the playfield and/or other game metadata, for example, score, penalties, and/or passed or remaining game time. The metadata is provided upon each input for capturing a highlight. In some embodiments, the metadata may be provided with each highlight or in an offline mode, for example, whereby highlights are collected and uploaded in a batch. The display 34 may display a number of captures or “taps” indicating a highlight and the player's name. A capture or “tap” may be manually input or may be activated based upon voice, for example.

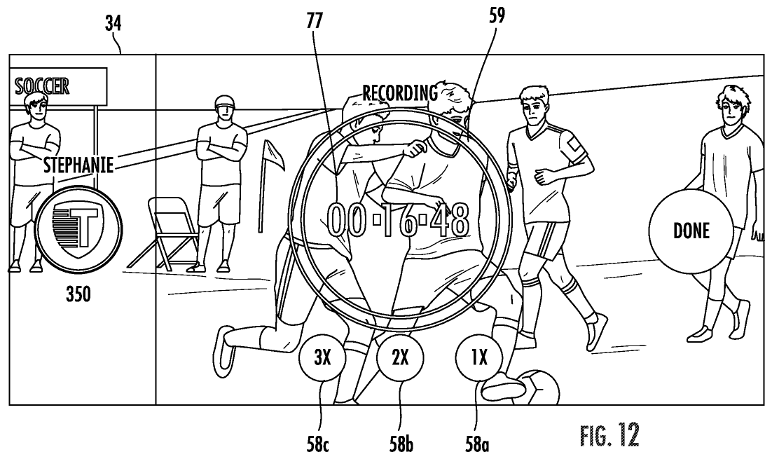

Alternatively, the given user (e.g., from among several users) may record, by way of the video camera 33, video 59, for example, of the game 54 (FIG. 12). The given user may select a desired zoom level, for example, 1× 58a, 2× 58b, and 3×, 58c. A textual notification 77 of the amount of video recorded in terms of time is also displayed on the display 34. The video 59 is wirelessly communicated from the mobile wireless communications device 30a to the video processing server 40 along with a timestamp, for example, a date and time as determined by the mobile carrier, and a relative time since start of recording. In some embodiments, the application may permit the given user to both record and note highlights at the same time. Multiple users may record the game. In some embodiments, one or more of the video cameras could be shared. In other words, for example, video from opposing teams may be shared, uploaded, or otherwise made available for selecting highlights and/or editing.

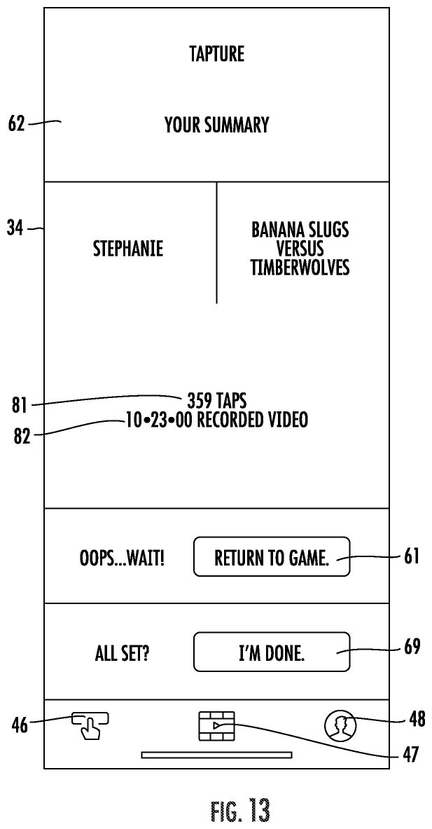

A summary 62 that includes a number of marked highlights (or taps or inputs) 81 from the user device 30a along with an amount of time of recorded video 82, if any, may be displayed on the display 34. The given user may be given the option 61 to return to the game 54 (e.g., for further identification of or marking of highlights and/or video capture) or select completion 64 (FIG. 13). The mobile wireless communications device 30a may wirelessly communicate the video as it is recorded to the video processing server 40 or communicate the video to the video processing server upon completion, in which case the captured video is stored in the memory 42. In other words, the video clip is obtained by the video processing server 40 from the user device.

Additional mobile wireless communications devices 30b-30n that execute the application may also function as described above, for example, to either or both of record video and accept input corresponding to a video highlight (FIG. 1). After a game, for example, the video processing server 40 compiles or aggregates the captured video or videos from each of the mobile wireless communications devices 30a-30n.

For each given user or user account, the video processing server 40 correlates the captured video or videos (i.e., video clips) with the given user's input corresponding to highlights, for example, based upon timestamps. The video processing server 40 may clip from the captured or raw video or videos, video before and after an input corresponding to a marked highlight. The amount of the video clip before and/or after the marked highlight may be user-settable, for example, 10 or 15-seconds before and after, or other user-settable threshold time. In some embodiments, the beginning and ending times may be adjusted based upon editing (e.g., locally on a mobile wireless communications device 30a-30n). The output quality, for example, in terms of resolution or frames per second, may be configured for the user-settable thresholds, either collectively or individually.

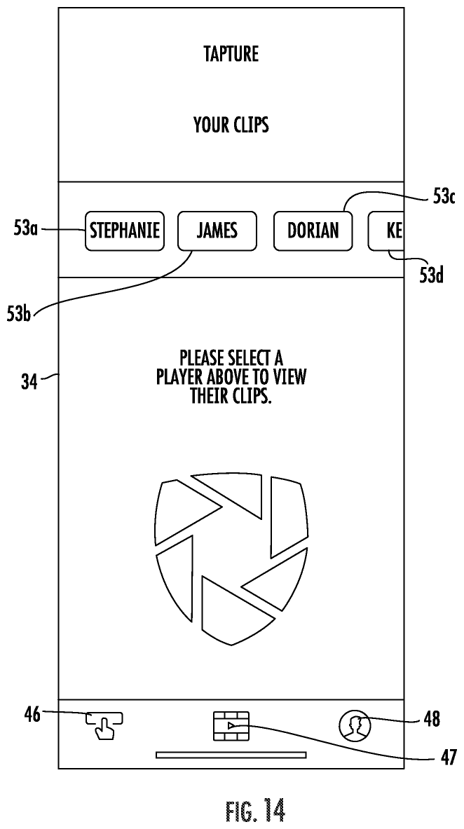

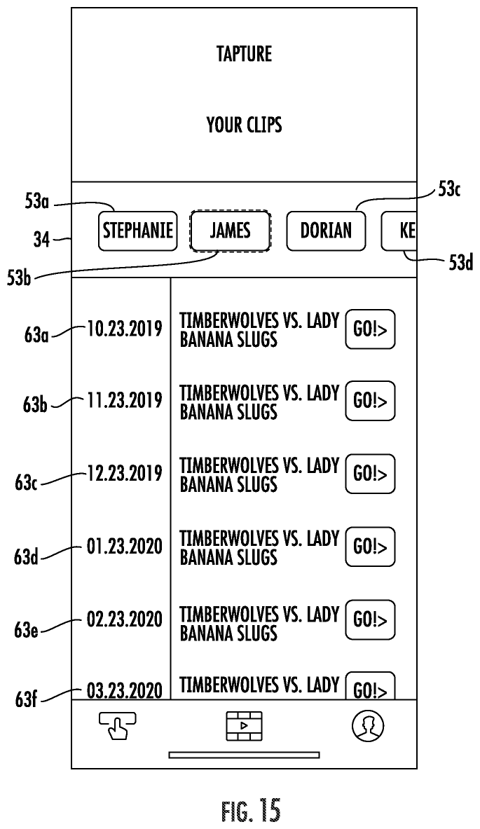

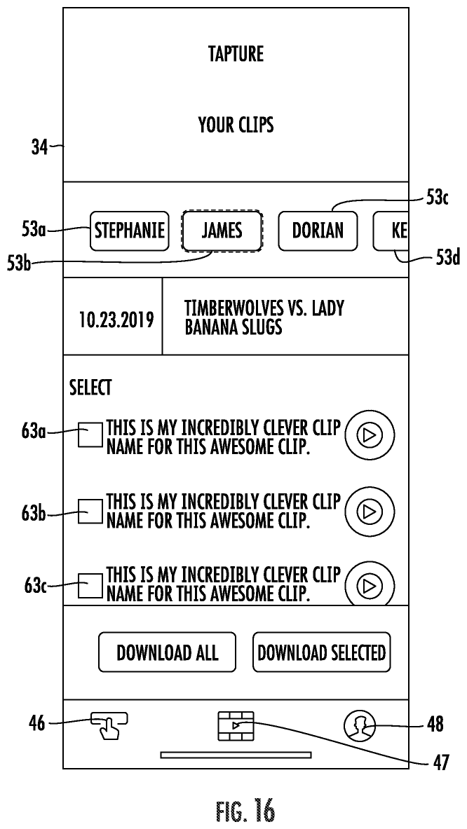

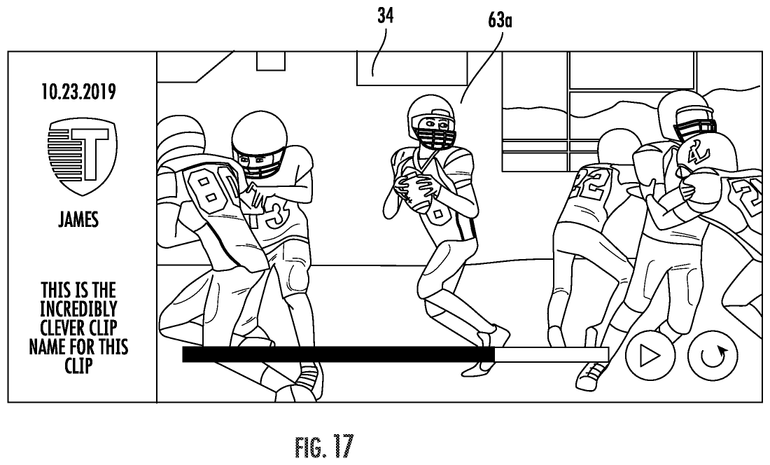

The video processing server 40 processes the video clip or clips to generate one or more corresponding video highlight clips 63a-63f based upon the marked highlight. A listing of available video highlight clips 63a-63f by game or date is communicated to from the video processing server 40 of the corresponding mobile wireless communications device 30a (FIG. 15), which may also be associated with a given player (e.g., from among several players 53a-53d associated with a given user) (FIG. 14). The given user may select the desired game to view the associated video clips (FIG. 16). A selected video clip 63a from the available video clips 63a-63c for the selected game are displayed or played on the display 34 (FIG. 17). The video processing server 40 may communicate the desired video clip based upon the user's selection from the listing of available video highlight clips 63a-63c. Video highlight clips 63a-63c may be renamed, for example, by the given user. Video highlight clips 63a-63c may be viewed or streamed from the video processing server 40 or downloaded to and stored on the mobile wireless communications device 30a. More particularly, the video processing server 40 may communicate video highlight clips 63a-63c to the user or mobile wireless communications device 30a so that each video highlight clip 63a-63c may be viewed on the display 34 of the mobile wireless communications device 30a.

In some embodiments, the video processing server 40 may permit, based upon input from the mobile wireless communications device 30a, communication of video clips 63a-63c to one or more desired recipients, for example, via email. In an embodiment, the video processing server 40 may permit rating or scoring (e.g., without displaying a player's name) of a given video clip. Statistics with respect to the ratings may be calculated or determined by the video processing server 40 and communicated to players or to users whose accounts are associated with players.

In some embodiments, video 59 may be recorded or obtained from a device that, while portable, may not include wireless communications circuitry. For example, one or more of the devices capturing video may be a camcorder. However, those skilled in the art will appreciate that input for marking or input corresponding to a highlight typically cannot be provided via a camcorder, and that selection of a highlight or a “tap” may be performed on a mobile wireless communications device 30a.

Further details of the video processing server 40 will now be described with respect to processing. A video clip of a live performance or game 54 may be stored a database within the memory 42, which includes game metadata and a list of players. Each list of players may be associated with their own metadata and a list of timestamps. The video processing server 40 may be notified via either completion of a file upload or a direct trigger that a video file for a game 54 is ready for processing. Given the name of the game object, the name of the video file and the starting timestamp of the game the video processing system sends a Kubernetes job to a Kubernetes cluster. This cluster provisions a self-contained stateless docker container to process the video file. The container runs on a worker instance whose properties (memory, CPU, local storage) are configurable for the job, and can be based on the memory and CPU requirements to effectively complete the job. This may permit provisioning of a cheaper container for a single low quality video file, or a more expensive one for games which have multiple, high-quality video streams. The docker container starts up, and grabs the video file from storage and game information from the database. The docker container checks to see if the video file has a time associated in its metadata, which it prefers over the time sent with the job. The docker container then iterates through the list of timestamps of each of the players of the game, creating a local folder structure to temporarily store the sliced video clips or files. The video processing server 40, which clips, truncates, or edits the video clips or files, can either re-encode the file or keep the current file bitrate and other quality settings depending on configuration, user/team subscription level or for other reasons. Additionally, at this point the video processing server 40 can add other aspects as an overlay to the media, such as player names, indicators highlighting the key player, game date/score and other aspects. Additionally, audio processing may be performed to reduce, minimize, or mute unwanted sounds (e.g., nearby verbal conversations, etc.).

Once the container has completed processing of all players and their corresponding timestamps, all of the video files are uploaded to a file storage system, access permissions are generated for those files, and then the respective accounts are notified that their video files are complete or ready. The application could also automatically receive the push notification and begin to download the players' video files as a background operation so that their video files are local to the given user's mobile wireless communications device 30a-30n and ready to be shared. Once all or a threshold number of users have been notified, the container “cleans-up” to return to its default state and is prepared to receive either another job or to shut down as needed. The Kubernetes cluster may include two separate pools, so that relatively expensive high-powered instances typically only run for operations need to be completed.

As will be appreciated by those skilled in the art, the video processing system 20 may be particularly advantageous for relatively quickly locating and obtaining desired video clips or highlights from among one or more videos. For example, a parent at a child's soccer game may only be interested in highlights of their child. However, when these highlights occur is typically unknown, and reviewing and editing videos of the game, for example, full-length videos of the entire game or multiple videos of different segments of the game, can be relatively time consuming. Thus, the parent may relatively quickly access desired highlights without searching the entire video of the game and editing that video 59.

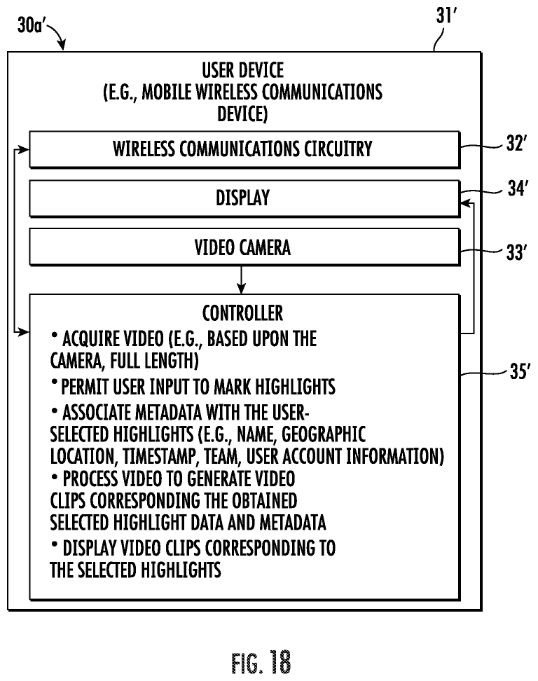

Referring briefly to FIG. 18, in another embodiment, the video processing operations may be performed on each mobile wireless communications device 30a′. In particular, the operations of the video processing server 40 may be performed by one or more mobile wireless communications device 30a. The controller 35′ may be configured to acquire a video clip via the video camera 33′ of a live performance, and permit input via the input device 36′ to mark a live performance highlight within the video clip of the live performance. The controller 35′ may also be configured to process the video clip of the live performance to generate a video highlight clip based upon the marked live performance highlight for display on the display 34′. The controller 35′ may cooperate with the wireless communications circuitry 32′ to communicate either or both of the acquired video clip or video highlight clip to another mobile device or server for view and/or further processing.

In some embodiments, the video processing may be shared between a given mobile wireless communications device 30a-30n and the video processing server 40. The video processing may be shared among multiple mobile wireless communications device 30a-30n and/or the video processing server 40. Also, in an embodiment, mobile wireless communications devices 30a-30n may connect to one another over a mesh network or via other mobile wireless communications devices that may not be recording live video, for performing the video processing. These other non-recording devices may obtain the video clip 59 for encoding and processing, for example, to reduce processing loads on any given mobile wireless communications device. Smaller video clips around the marked live performance highlight may be selected, for example, so that a mobile wireless communications device 30a-30n may record the video clip of the live performance while processing the video clip.

A method aspect is directed to a method of processing video. The method includes operations of capturing, editing or processing, and communicating videos as described herein. More particularly, a method aspect is directed to a video processing method that may include operating a user device 30a′ of a video processing system to acquire a video clip of a live performance via a video camera 33′ of the user device. The method also includes operating the user device 30a′ to permit input via an input device 36′ of the user device to mark a live performance highlight within the video clip of the live performance, and process the video clip of the live performance to generate a video highlight clip based upon the marked live performance highlight.

Another method aspect is directed to a video processing method that includes operating a video processing server 40 of a video processing system to obtain a video 59 clip of a live performance from a video camera 33 of a user device of the video processing system 20. The video clip of the live performance includes a marked live performance highlight marked via an input device from the user device. The method further includes operating the video processing server 40 to process the video clip of the live performance to generate a video highlight clip 63a-63c based upon the marked live performance highlight, and communicate the video highlight clip 63a-63c corresponding to the marked performance highlight to the user device for display 34 thereon.

A computer readable medium aspect is directed to a non-transitory computer readable medium for video processing. The non-transitory computer readable medium includes computer executable instructions that when executed by a controller of user device cause the controller to perform operations. The operations include acquiring a video clip of a live performance via a video camera 33′ of the user device, and permitting input via an input device 36′ of the user device 30a′ to mark a live performance highlight within the video clip of the live performance. The operations also include processing the video clip of the live performance to generate a video highlight clip based upon the marked live performance highlight.

Another computer readable medium aspect is directed to a non-transitory computer readable medium for video processing. The non-transitory computer readable medium includes computer executable instructions that when executed by a processor of a video processing server 40 cause the processor to perform operations. The operations include obtaining a video clip of a live performance from a video camera 33 of a user device of the video processing system 20. The video clip of the live performance includes a marked live performance highlight marked via an input device from the user device. The operations also include operating the video processing server 40 to process the video clip of the live performance to generate a video highlight clip 63a based upon the marked live performance highlight, and communicating the video highlight clip 63a corresponding to the marked performance highlight to the user device for display thereon.

While several embodiments have been described herein, it should be appreciated by those skilled in the art that any element or elements from one or more embodiments may be used with any other element or elements from any other embodiment or embodiments. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included.

That which is claimed is:

1. A video processing system comprising:
a user device comprising
a video camera,
an input device, and
a controller coupled to the video camera and the input device, the controller configured to
acquire a video clip via the video camera of a live performance, and
permit input via the input device to mark a live performance highlight within the video clip of the live performance; and
a video processing server comprising a processor and an associated memory and configured to
obtain the video clip of the live performance including the marked live performance highlight from the user device,
process the video clip of the live performance to generate a video highlight clip based upon the marked live performance highlight, and
communicate the video highlight clip corresponding to the marked performance highlight to the user device for display thereon.

2. The video processing system of claim 1 wherein the video processing server is configured to process the video clip to generate the video highlight clip by moving backward a threshold time before the marked live performance highlight.

3. The video processing system of claim 1 wherein the video processing server is configured to process the video clip to generate the video highlight clip by moving forward a threshold time after the marked live performance highlight.

4. The video processing system of claim 1 wherein the user device is configured to associate metadata with the video clip; and wherein the video processing server is configured to process the video clip to generate the video highlight clip based upon the metadata.

5. The video processing system of claim 1 wherein the metadata comprises at least one of username, geographic location, time, team name, and account information.

6. The video processing system of claim 1 comprising a further user device configured to acquire a further video clip of the live performance; and wherein the video processing server is configured to aggregate the further video clip with the video clip of the live performance.

7. The video processing system of claim 1 comprising a further user device configured to permit input to mark a further live performance highlight.

8. The video processing system of claim 1 wherein the user device comprises wireless communications circuitry and a display coupled to the controller.

9. The video processing system of claim 1 wherein the input device comprises an accelerometer; and wherein the input to the input device comprises movement of the user device while acquiring the video clip.

10. A user device for a video processing system, the user device comprising:
a video camera;
an input device; and
a controller coupled to the video camera and the input device, the controller configured to
acquire a video clip via the video camera of a live performance,
permit input via the input device to mark a live performance highlight within the video clip of the live performance, and
process the video clip of the live performance to generate a video highlight clip based upon the marked live performance highlight.

11. The user device of claim 10 wherein the controller is configured to associate metadata with the video clip, and generate the video highlight clip based upon the metadata.

12. The user device of claim 11 wherein the metadata comprises at least one of username, geographic location, time, team name, and account information.

13. The user device of claim 11 comprising wireless communications circuitry and a display coupled to the controller.

14. The user device of claim 11 wherein the input device comprises an accelerometer; and wherein the input to the input device comprises movement of the user device while acquiring the video clip.

15. A video processing server for a video processing system comprising a user device, the video processing server comprising:
a processor and an associated memory configured to
obtain a video clip of a live performance from a video camera of the user device, the video clip of the live performance including a marked live performance highlight marked via an input device from the user device,
process the video clip of the live performance to generate a video highlight clip based upon the marked live performance highlight, and
communicate the video highlight clip corresponding to the marked performance highlight to the user device for display thereon.

16. The video processing server of claim 15 wherein the processor is configured to process the video clip to generate the video highlight clip by moving backward a threshold time before the marked live performance highlight.

17. The video processing server of claim 15 wherein the processor is configured to process the video clip to generate the video highlight clip by moving forward a threshold time after the marked live performance highlight.

18. A video processing method comprising:
operating a user device of a video processing system to
acquire a video clip of a live performance via a video camera of the user device,
permit input via an input device of the user device to mark a live performance highlight within the video clip of the live performance, and
process the video clip of the live performance to generate a video highlight clip based upon the marked live performance highlight.

19. The method of claim 18 wherein operating the user device comprises operating the user device to associate metadata with the video clip to generate the video highlight clip based upon the metadata.

20. The method of claim 19 wherein the metadata comprises at least one of username, geographic location, time, team name, and account information.

21. A video processing method comprising:
operating a video processing server of a video processing system to
obtain a video clip of a live performance from a video camera of a user device of the video processing system, the video clip of the live performance including a marked live performance highlight marked via an input device from the user device,
process the video clip of the live performance to generate a video highlight clip based upon the marked live performance highlight, and
communicate the video highlight clip corresponding to the marked performance highlight to the user device for display thereon.

22. The method of claim 21 wherein operating the video processing server comprises operating the video processing server to process the video clip to generate the video highlight clip by moving backward a threshold time before the marked live performance highlight.

23. The method of claim 21 wherein operating the video processing server comprises operating the video processing server to process the video clip to generate the video highlight clip by moving forward a threshold time after the marked live performance highlight.
